(19) United States
(12) Patent Application Publication
(10) Pub. No.: US 2026/0078463 A1
(43) Pub. Date: Mar. 19, 2026

(54) METHOD FOR MONITORING A STEEL PROCESSING LINE, ASSOCIATED ELECTRONIC DEVICE AND STEEL PROCESSING LINE

(71) Applicant: ArcelorMittal, Luxembourg (LU)

(72) Inventor: Frédéric BONNET, AVRIL (FR)

(21) Appl. No.: 19/476,768

(22) PCT Filed: Apr. 28, 2023
(86) PCT No.: PCT/IB2023/054414

§ 371 Date: Oct. 20, 2025

(51) Int. Cl. C21D 11/00

(52) U.S. Cl. CPC C21D 11/00

(57) ABSTRACT

A method for monitoring a steel processing line that includes: a control module which determines line control signals for controlling the steel processing line, the line control signals being determined depending on a chemical composition of a steel semi-product being processed and depending on a target property for the semi-product, and an abnormality detector, which determines an abnormality indicator which specifies whether the line control signals are normal or abnormal, an abnormality cause selected in a list of predetermined abnormality causes being then specified, the abnormality indicator being determined using a trained classifier whose inputs comprise at least: the chemical composition, the target property, and the line control signals.

The present invention relates to a method for monitoring a steel processing line that processes a steel semi-product to detect a possible process parameter drift, a possible product parameter drift, or a possible process actuator malfunction. The invention also relates to an associated abnormality detector, and to a method for training such detector.

### BACKGROUND

During the production of steel sheets, for instance, the sheets are subjected to several thermal treatments in order to obtain a targeted microstructure and properties for a specific application. Such thermal treatments can be, for example, a continuous thermal treatment before deposition of a metallic coating or a quenching and partitioning treatment.

### SUMMARY OF THE INVENTION

During the thermal treatment in the continuous thermal treatment line, the process parameters are chosen to obtain the targeted microstructure and properties at the end of the process. These process parameters comprise the thermal path, which corresponds to the successive temperatures, heating and cooling rates and time spent in each section of the thermal treatment process.

During the thermal treatment, some of the processing steps may be impaired by a malfunction of such actuator of the continuous thermal treatment line, or by a drift of such operation condition (like the temperature of an inert gas in a furnace of the thermal treatment line, or a drift of the sheet speed), thus requiring a modification of other process parameters and/or causing a deviation from the targeted properties and microstructure. In addition, some discrepancies in chemical composition are possible, which can modify the targeted final microstructure and properties.

The patent application publication WO2013023903 relates to a method for operating a continuous thermal treatment line for processing a rolled steel strip, comprising: using a measuring device to measure a property of the rolled steel strip, supplying the property of the rolled steel strip as an input variable to a model of a control device, using the model and the property of the rolled steel strip to predict a material property of the rolled steel strip after the continuous thermal treatment line and to produce a predicted material property, comparing the predicted material property with a predetermined target value, and, if the simulated material property deviates from the target value, at least one process variable of the continuous thermal treatment process is regulated.

In this method, the model is used during the production, for each production campaign, in order to perform regulation during this production campaign.

More generally, the operation of a steel-processing line, like a hot rolling line, a cold rolling line, a pickling line or an annealing line, is regulated, controlled, for instance using feed-back control, to obtain a final product having the desired property in spite of possible deviations of operation conditions, or in spite of possible actuators saturation or malfunction. These regulations enable to compensate, at least partially, for such deviations or malfunctions. But they do not allow identifying which process or product parameter is drifting, or which actuator is malfunctioning.

Identifying that such actuator is malfunctioning is beneficial as it enables planning adequate maintenance or repair. In particular, it avoids letting the malfunction getting worse, to a point needing an unplanned, abrupt stop of the processing line. Similarly, identifying that a process or a product parameter is drifting away from values corresponding to normal operation conditions is beneficial, as it enables to remedy this drift, preferably before it gets critical. Such a detection is also beneficial as it enables to adjust process parameters to compensate for the drift or malfunction to maintain product quality.

It is an object of the invention to provide a method for monitoring a steel processing line, allowing detecting that operation conditions are abnormal, and allowing identifying a cause of abnormality among a list of predetermined abnormality causes.

The present invention provides a method for monitoring a steel processing line (1) during the processing of a steel semi-product (6), the steel processing line (1) comprising sensors (2), actuators (3) and an electronic device (10) that comprises a control module (11) and an abnormality detector (12),
method wherein the control module:
   acquires:
      a chemical composition CC of the steel semi-product;
      a target property P for the steel semi-product, to be obtained at the end of said processing;
      monitoring signals (MS), output by the sensors (2) of the steel processing line, the monitoring signals being representative of operation conditions (T_{g}), or of intermediary properties (Tₛ, T_{s′}) of the steel semi-product,
   determines line control signals (MP) for controlling the actuators (3) of the steel processing line, the line control signals being determined as a function of the chemical composition CC, the target property P and the monitoring signals (MS), and being determined using a steel property predictive model,
   controls the actuators (3) based on the line control signals (MP),
and wherein the abnormality detector (12) determines and outputs an abnormality indicator (ind) which specifies whether the line control signals (MP) are normal or abnormal, an abnormality cause (ACₖ) selected in a list of predetermined abnormality causes being then specified, the abnormality indicator (ind) being determined using a trained classifier, the trained classifier inputs comprising:
   the chemical composition CC of the steel semi-product,
   the target property P, or an estimated final property (P_{EST}) of the steel semi-product determined by the control module (11), and
   the line control signals (MP),
the trained classifier having been previously trained using a number of labelled training data, each labelled training data comprising:
   steel processing data, of the same type as the trained classifier inputs, and
   a label, specifying whether the steel processing data are normal or abnormal, one of the abnormality causes of said list being then specified.

In case of a drift of an operation condition, for instance a drift of the temperature of an inert gas present in a furnace, one of the monitoring signals will change (in this case, a signal, output by a temperature sensor set up in the furnace, will change). The control module will then adjust one or more of the line control signals (for instance the one controlling radiant tubes in the furnace), depending on this monitoring signal variation, to try to obtain the desired target property at the end of the process, in spite of this variation of the operation conditions. In such situation, the line control signals will thus have values that are different from the ones in normal, reference operation conditions. Line control signals, in such situation are thus “abnormal”, that is different from the ones in normal, reference operation conditions. An analysis of the line control signals, to detect whether they are abnormal or not, may thus enable, in principle, to detect that there is a drift or a malfunction. Similarly, if one of the cooling jets of a cooling device is inoperative, the control module will adjust the powers of the other cooling jets to compensate for this, which will be reflected by abnormal, “unusual” line control signals, which may be detectable, in principle.

Though such a detection may be possible in principle, it is not clear that it is indeed achievable in practice, nor how to achieve it. Indeed, on such a steel processing line, monitoring signals and line control signals vary (sometimes significantly) over time and from one semi-product to the other, as the characteristics of the successive semi-products to be processed, like their size or chemical composition, usually vary from one semi-product to the other, as well as the targeted properties (for instance the desired final tensile strength). So, even for a defect-free operation, the monitoring signals varies.

To deal with such inherent variability, the detection method combines:
taking into account the line control signals output by the control module, together with the chemical composition of the steel semi-product and the target property aimed at (or the estimated final property of the steel semi-product), and
using a trained classifier.

The inventors have observed that this approach enables indeed to detect an abnormality, and to identify its cause. In other words, it enables to identify a signature of the abnormality, within the line control signals, in spite of the complexity of the situation and in spite of their natural variability in normal conditions.

Test results, illustrating the efficiency of this method, are presented in the detailed description.

It is noted that the monitoring method described above does not necessarily comprise the training of the trained classifier: in general, the trained classifier is trained previously (during a step-up phase), before the monitoring method starts.

Some of the labeled training data, employed to train the classifier, may be simulated training data instead of previously recorded, actual steel processing data. This is useful, as drifts and malfunctions do not happen often on a steel processing line (as one tries to avoid them). So, simulating abnormal steel processing data enables to have at hand processing data that correspond to drift or failure scenarios that may happen in the future, but did not happen previously on the line. So, using such simulated training data enables an extensive exploration of abnormality causes. Once trained, the classifier capitalizes the substantial simulation and training work that has been achieved, which then enables, once in the use-phase of the trained classifier, real time and accurate detection of an abnormality in the line control signals, in spite of the a priori complexity of such a detection/analysis.

The simulated training data above mentioned may in particular be calculated using the same control module as the one employed for controlling the processing line (or using a numerical copy of this control module). In other words, the simulated training data may be calculated using the same steel predictive model and the same calculation rules as the one employed by the control module for calculating the actual line control signals.

The present invention also provides an electronic device (10) for controlling a steel processing line (1) that comprises sensors (2) and actuators (3) and that is suitable for processing a steel semi-product (6), the electronic device (10) comprising a control module (11) and an abnormality detector (12),
the control module being configured to execute the following steps:
   acquiring:
      a chemical composition CC of the steel semi-product;
      a target property P for the steel semi-product, to be obtained at the end of said processing;
      monitoring signals (MS), output by the sensors of the steel processing line, the monitoring signals being representative of operation conditions (T_{g}), or of intermediary properties (Tₛ) of the steel semi-product,
   determining line control signals (MP) for controlling the actuators of the steel processing line, the line control signals being determined as a function of the chemical composition CC, the target property P and the monitoring signals (MS), and being determined using a steel property predictive model,
   controlling the actuators based on the line control signals,
the abnormality detector (12) being configured to determine and output an abnormality indicator (ind) which specifies whether the line control signals (MP) are normal or abnormal, an abnormality cause selected in a list of predetermined abnormality causes (ACₖ) being then specified, the abnormality indicator (ind) being determined by a trained classifier, the trained classifier inputs comprising:
   the chemical composition CC of the steel semi-product,
   the target property P, or an estimated final property (P_{EST}) of the steel semi-product determined by the control module, and
   the line control signals (MP),
wherein the trained classifier is a classifier that has been previously trained using a number of labelled training data, each labelled training data comprising:
   steel processing data, of the same type as the trained classifier inputs, and
   a label, specifying whether the steel processing data are normal or abnormal, one of the abnormality causes of said list being then specified.

The present invention also provides a steel processing line (1) comprising sensors (2), actuators (3), and the electronic device (10) as described above.

The present invention also provides a method for training a classifier of an abnormality detector (12) of an electronic device (10), the electronic device comprising a control module (11) for controlling a steel processing line (1) that comprises sensors (2) and actuators (3) and that is suitable for processing a steel semi-product (6),
the control module being configured to execute the following steps:
   acquiring:
      a chemical composition CC of the steel semi-product;
      a target property P for the steel semi-product, to be obtained at the end of said processing;
      monitoring signals (MS), output by the sensors of the steel processing line, the monitoring signals being representative of operation conditions (T_{g}), or of intermediary properties (Tₛ) of the steel semi-product,
   determining line control signals (MP) for controlling the actuators of the steel processing line, the line control signals being determined as a function of the chemical composition CC, the target property P and the monitoring signals (MS), and being determined using a steel property predictive model,
   controlling the actuators based on the line control signals,
   method wherein the classifier is trained using a number of labelled training data, each labelled training data comprising:
   steel processing data, of the same type as the trained classifier inputs, and
   a label, specifying whether the steel processing data are normal or abnormal, one of the abnormality causes of said list being then specified,
   wherein at least some of the labelled training data are simulated training data calculated using the same steel predictive model and the same calculation rules as the one employed by the control module for calculating said line control signals and while one of said abnormality cause is present.

The present invention also provides a computer program comprising instructions whose execution on a computer device, connected to sensors and actuators of a steel processing line, make the computer device to execute the method as described above.

### BRIEF DESCRIPTION OF THE DRAWINGS

The present invention will now be described in detail and illustrated by examples without introducing limitations, with reference to the appended figure:

FIG. 1 is a synoptic representation of a steel processing line according to the invention,

FIG. 2 schematically represents a step of determining line control signals for controlling the steel processing line of FIG. 1,

FIG. 3 represents in more detail the steel processing line of FIG. 1, where the steel processing line is a hot-dip galvanization line comprising a thermal treatment installation, and

FIG. 4 is a flowchart representing steps executed to obtain simulated labeled training data for training an abnormality detector of the steel processing line of FIG. 1.

### DETAILED DESCRIPTION

Some general aspects of the present invention will be presented first. More detailed explanations regarding the implementation of an abnormality detector for a steel processing line are presented then, in the case where the processing comprises a thermal treatment. A numerical example is finally described.

### Steel Processing Line

FIG. 1 represents a steel processing line 1 for processing a steel semi-product 6. The steel semi-product can be a steel sheet, like a hot-rolled or cold-rolled steel sheet, a slab, a billet, a broom, an ingot, a bar, a beam, a tube or a wire. More generally, the steel semi-product is an intermediary source-product, destinated, subsequently, to manufacture a part, a good or a construction.

The steel processing line 1 may be a continuous processing line, suitable for processing steel semi-products with no interruption between them. The steel processing line may comprise a furnace, like a heating or an annealing furnace, a roughing or a finishing mill, a run-out table, or another kind of thermal treatment installation (including a controlled cooling device, or a furnace, a soaking device and a controlled cooling device). The steel processing line 1 may be a hot-rolling line, a cold-rolling line, a pickling line, a hot-dip galvanization line, or another steel processing line. It may also include two or more of the above-listed processing lines.

The steel processing line 1 comprises actuators 3, to actuate the steel processing line for processing the steel semi-product 6. The actuators 3 comprise for instance furnace heaters, motors for rotating rollers, colling devices (gas or water jets, for instance) and/or roller jacks.

The steel processing line 1 comprises also sensors 2, suitable to output monitoring signals MS representative:
of operation conditions, like the temperature or composition of a gas filling a furnace, or like a measured moving speed of a steel sheet, or force exerted by mill rollers,
and/or of intermediary properties of the steel semi-product 6 being processed, like a temperature, a dimension, a measured microstructure or emissivity of the steel semi-product at a given, intermediary position in the steel processing line (or at the beginning of it).

The sensors 2 may comprise one or several of the following: a temperature probe, a pyrometer, a scanner, a laser sensor for measuring a sheet moving speed or a sheet thickness, a barometer, a gas composition analyser, a camera or a set of cameras, an ultrasound sensor, a volt- or amperemeter for measuring the voltage or current supplied to one of the actuators.

The steel processing line 1 also comprises an electronic device 10 including a control module 11 and an abnormality detector 12. The electronic device 10 comprises at least one processor and one memory. It has the structure of a computer device or system. It is configured, for instance programmed, to execute the monitoring method according to the invention. The control module 11 and the abnormality detector 12 may take the form of two distinct electronic units. They may also correspond to two distinct groups of instructions (two distinct programs, or sub-programs). The control module 11 and the abnormality detector 12 operation is described in more detail later.

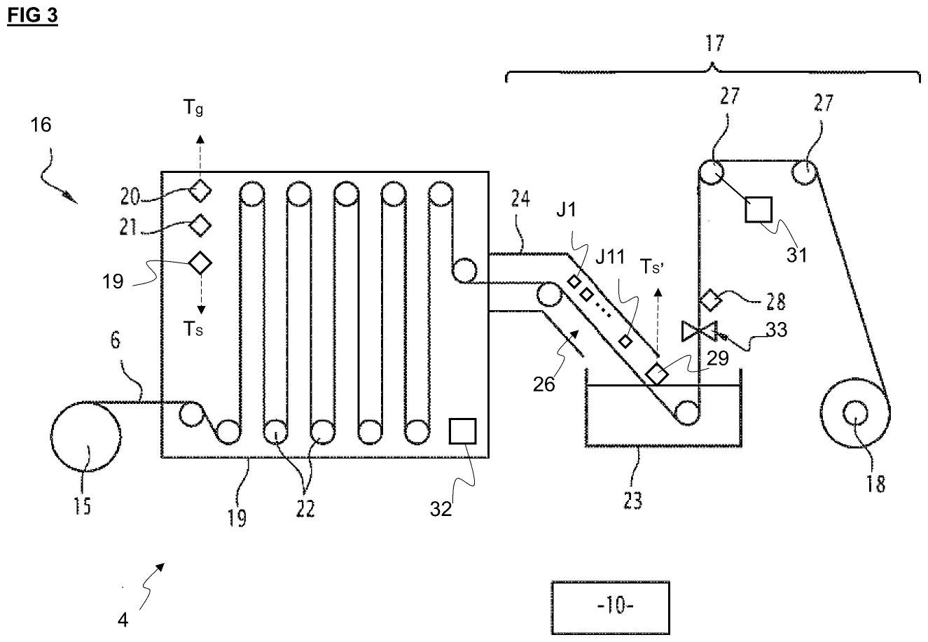

The steel processing line 1 may in particular comprise a thermal treatment installation (it is the case for instance when the line is a hot-dip galvanization line), to apply a thermal treatment to a steel sheet. During the thermal treatment, the sheet is subjected to at least one cooling step, and possibly one heating step, according to a thermal path. Usually, thermal treatments can be performed in an oxidizing atmosphere, i.e., an atmosphere comprising an oxidizing gas being for example: O₂, CH₄, CO₂ or CO. They also can be performed in a neutral atmosphere, i.e., an atmosphere comprising a neutral gas being for example: N₂, Ar or He. Finally, they also can be performed in a reducing atmosphere, i.e., an atmosphere comprising a reducing gas being for example: H₂ or HNx. The thermal path can also include at least one isothermal holding step, that can usually be preceded by a heating step and followed by a cooling step. The cooling step can comprise an isothermal holding, called an overaging sub-step followed by a subsequent cooling step. A hot-dip coating step in a hot metal bath (like the hot bath 23 of FIG. 3 can also be used during such thermal path and is another type of isothermal holding as the metallic sheet dipped in such hot metal bath will be maintained at the bath temperature during its retention time in such bath.

Said thermal treatment can be, for example, chosen among the following treatments;
recrystallization annealing,
tempering,
recovery,
quench and tempering,
quench and partitioning.

FIG. 3 represents in more detail the steel processing line of FIG. 1, in a case where the steel processing line is a hot-dip galvanization line 4. The hot-dip galvanization line 4 comprises a decoiler 15, an annealing furnace 16, a coating device 17 and a coiler 18.

The annealing furnace 16 is equipped for example with a first sensor 19 for measuring a temperature Tₛ of the steel semi-product 6 (here a steel sheet), with a second sensor 20 for measuring a temperature of a gas filling the annealing furnace, and with a third sensor 21 for determining a composition of that gas. The annealing device 16 also includes rollers 22 for guiding the steel sheet, and a heating device 32 (like ceramic radiant tubes).

The coating device 17 comprises a snout 24 housing a cooling device 26, the bath 23 of molten metal, for example molten zinc, a wiping device 33, and rollers 27 for guiding the steel sheet. The cooling device 26 comprises cooling jets, here eleven successive cooling jets J1 to J11 each spraying HNx. The coating device 17 is also equipped with a fourth sensor 28 for measuring a coating thickness on the sheet after wiping, and a fifth sensor 29 for measuring a sheet temperature after cooling T_{s′}. The coating device 17 comprises also at least one electric motor 31, for driving one of the rollers 27.

### Control Module

The control module 11 is configured to execute the following steps:
acquiring:
   a chemical composition CC of the steel semi-product 6;
   a target property P for the steel semi-product, to be obtained at the end of the process;
   the monitoring signals MS, output by the sensors 2 of the steel processing line,
determining line control signals MP for controlling the actuators 3 of the steel processing line 1, the line control signals MP being determined as a function of the chemical composition CC, the target property P and the monitoring signals MS, and being determined using a steel property predictive model,
controlling the actuators 3 based on the line control signals MP.

The monitoring signals and line control signals are not necessarily time-varying signals: They can each be a constant set value for setting one of the process parameters.

The target property P can be a mechanical property, like the tensile strength, the yield strength, the total elongation, the uniform elongation, the hole expansion ratio, or the impact toughness. It can also be a dimension of the steel semi-product, like the thickness of the sheet, or the length of a coil made of such sheet. It may also be a thermal property like a coiling temperature, or a radiative property like an emissivity of the steel semi-product. It can also be a target microstructure, or a target surface finish (e.g.: a target surface roughness). The control module 11 may acquire not just one but a plurality of such target properties and then determining the line control signals MP as a function of this plurality of target properties.

As represented in FIG. 1, the control module 11 may also acquire one or more process parameters of a previous process, underwent by the steel semi-product 6 before being processed in the steel processing line 1. Such a previous process parameter PPP is for example a reducing ratio of a previous hot-rolling or cold-rolling operation. In addition to the chemical composition CC, the control module 11 may also acquire one or more additional product parameters APP relative to the steel semi-product 6, like its initial dimensions and/or an initial microstructure the steel semi-product has before entering the steel processing line, this microstructure having been determined using a sensor and/or a model. In such a case, the control module 11 takes into account the previous process parameter(s) PPP and/or the additional product parameter(s) APP, when determining the line control signals MP.

At least some of the monitoring signals MS are taken into account by the control module 11 to regulate corresponding processing conditions (like a steel sheet speed), in a close-loop control manner, so that these processing conditions match desired processing conditions, in spite of possible process fluctuations or other disturbances. The desired processing conditions in question may be calculated using the steel property predictive model, depending on the chemical composition CC and to lead, at the end of the process, to the one or more target properties mentioned above.

The steel property predictive model is a computation tool providing a relationship (in other words, a link) between:
the one or more target properties,
the chemical composition CC, and possibly the previous process parameter(s) PPP and/or the additional product parameter(s) APP, and
operation conditions for said process (like temperatures a given points in the process, and/or the steel sheet speed), or possibly, a relationship directly with the control signals MS to be used to control the actuators 3.

This relationship may take the form of one or more mathematical formulas (either explicit or implicit) and/or a Look Up Table and/or an iterative computation and/or another computing algorithm. The steel property predictive model may be based on a physical modelisation of the process and/or on a so-called “black-box model” based on data analysis (achieved for instance using a machine learning algorithm).

When the steel processing line 1 is a hot-dip galvanisation line such as the one of FIG. 3, or more generally comprises thermal treatment elements, the control module 11 may be based on the computer program or method described in document EP3559284 or in document EP3559287, for instance. When the steel processing line 1 is, or comprises a run-out-table, the control module 11 may be the control apparatus described in document EP3645182.

The control module 11 may implement a dynamic control of the steel processing line 1, in which operations conditions on a second part of the line are adjusted depending on monitoring signals, representative of operation conditions or product parameters measured on a first, previous part of the line. The operation conditions on the second, subsequent part of the line are then adjusted as to compensate for deviations observed on the first part of the line (deviations between desired, and actually measured operation conditions, or product parameters), to obtain the one or more target properties in spite of this deviation. Such a dynamic control is implemented for instance like described in document EP3559287.

The control module 11 may be configured to calculate also one or more estimated final properties P_{EST} of the steel semi-product 6, expected at the end of the process, given the chemistry composition CC, the monitoring signals MS acquired, and/or the line control signals MP determined by the control module. The one or more estimated final properties P_{EST} are of the same type as the one or more target properties above mentioned, but they are more accurate predictions for what is expected at the end of the process. Indeed, the steel property predictive model may be configured to iteratively determine operation conditions (for instance a thermal route) enabling to obtain final properties that are close to the target properties (within a compliance range), but not necessarily exactly equal to the target properties. So, once this thermal route is chosen, the final properties expected at the end of the process may be slightly different from the target ones. Similarly, the control module may compute different operation conditions, and then select the one leading to the properties that are the closest to the target properties (yet not exactly equal to them).

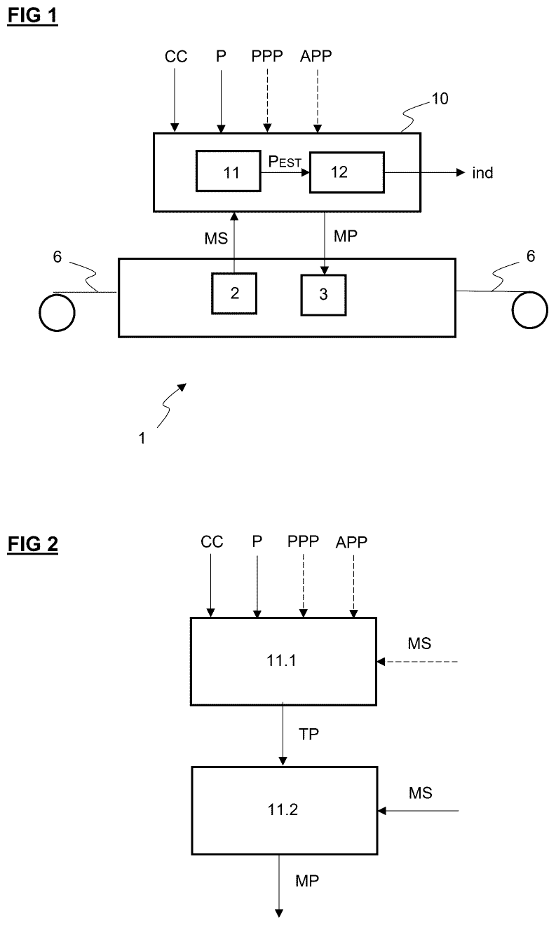

FIG. 2 schematically represents how the determination of the line control signals MP may be organised. As represented in FIG. 2, during a first step 11.1, desired operation conditions OC are determined, taking into account the one or more target properties (including target property P), the chemical composition CC, and, optionally, the previous process parameter(s) PPP and/or the additional product parameter(s) APP. This step is achieved using the steel property predictive model. The desired operations conditions OC can be determined based also on one or more of the monitoring signals MS, in particular when the steel property predictive model implements a dynamic adjustment of the operation conditions, as above explained.

When the process comprises a thermal treatment, the desired operation conditions typically comprise the thermal path TP to be followed by the steel semi-product.

In the next step 11.2, the line control signals MP are determined, depending on the desired operation conditions OC to be obtained, and depending on the monitoring signals MS. The control signals MP may be determined based on pre-established calculation rules representative of operation characteristics of the actuators or of the line, and/or using regulation techniques (e.g.: close-loop regulation).

During step 11.2, the control module 11 determines also the one or more estimated final properties P_{EST} of the steel semi-product 6. Still, these properties could alternatively be determined directly during step 11.1 (before step 11.2).

Different sets of line control signals are often possible in principle to obtain such desired operation conditions, or final properties. The control module may thus be configured to determine more than one set of line control signals. In such case, one of these possible sets of control signals is selected, and then used to control the steel processing line 1. The set of control signals which is selected is for instance the one leading to the one or more estimated final properties P_{EST} that are the closest to the one or more target properties P.

When the process comprises a thermal treatment, the line control signals MP (or, in other words, the manufacturing parameters MP), determined in step 11.1, may comprise process settings for controlling a furnace heating device, for controlling the powers of the cooling jets and/or for controlling the speed(s) of the semi-product in the different sections of the line. The speed(s) in question may be determined taking into account a maximum speed, achievable in principle on the line given the dimensions or weight of the steel semi-product. More generally, the line control signals MP are signals, or more simply set points for controlling one or more of the line actuators.

Regarding the powers of cooling jets, different combination of powers can be considered. For instance, the power of the first cooling jet of the series of successive cooling jets could be higher than for the following jets (which is usually called an “early cooling”). On the contrary, the power of the last cooling jet of the series could be higher (“late cooling”). Or the cooling power could be evenly distributed among the different jets. And there are many other power distribution possibilities. The control module 11 may determine the powers of the cooling jets according to one of these cooling strategies (“early cooling for instance”), and depending on the desired thermal path determined in step 11.1. Alternatively, the control module 11 may determine different sets of candidate line control signals, according to these different cooling strategies respectively, and then select one of sets of candidate line control signals, as being the more adequate given the target property P. The selected cooling strategy is for instance the one leading to the one or more estimated final properties P_{EST} that are the closest to the one or more target properties P.

As above mentioned, there are often different possible sets of line control signals, suitable to obtain one or more final properties close to the one or more target properties of the steel semi-product. Indeed, the steel processing line 1 usually comprises numerous actuators, whose effects are partially redundant or complementary. So, should one of the actuators 3 be partially or totally inoperative, it is possible to compensate this failure, at least partially, by adjusting consequently the line control signals controlling the other actuators. In this regard, the control module 11 (should it operate according to FIG. 2, or differently) is programmed here so that it is able to determine a set of line control signals, as suitable as possible, given that one of the actuators is off or partially off. In other words, the control module 11 is able to determine the set of line control signals while assuming that one or more of the actuators are off or partially off. In the case of cooling jets, for instance, the control module 11 is able to determine colling jets powers, as suitable as possible in view of obtaining the one or more target properties, assuming that one or the jets if off. In such case, the other jets powers are determined so as to compensate for the non-operative jet.

### Abnormality Detector

The abnormality detector 12 is configured to determine and to output an abnormality indicator ind (FIG. 1) which specifies whether the line control signals MP are normal or abnormal, an abnormality cause selected in a list of predetermined abnormality causes ACₖ, k being an integer from 1 to z, being then specified. The abnormality indicator ind may be output by a user interface such as a display screen. It may also be output by transmitting the abnormality indicator to the control module 11, or to another control element, in view of an automatic treatment, and possibly in view of an automatic implementation of countermeasures when an abnormality is detected. The abnormality detector 12 can be considered as a “meta-sensor”, determining process or product characteristics (here, faults, or drifts) from data derived from measurements (e.g.: from steel sheet temperature measurements). In other words, it implements a kind non-direct measurement method.

The abnormality detector 12 determines the abnormality indicator ind using a trained classifier whose inputs comprise:
the chemical composition CC of the steel semi-product,
the one or more target properties P, or the one or more estimated final properties P_{EST} of the steel semi-product 6 determined by the control module 11 (for instance estimated final tensile strength and microstructure), and
the line control signals MP.

The trained classifier inputs may also comprise one or more of the monitoring signals MS.

Before being employed in the steel processing line 1, the abnormality detector 12 has been trained using a number of labelled training data, each labeled training data comprising:
steel processing data, of the same type as the trained classifier inputs (and thus comprising a chemical composition, one or more product properties-like a target tensile strength and target microstructure—and associated line control signals), and
a label, specifying whether the steel processing data are normal or abnormal, one of the abnormality causes of said list being then specified.

The labels of the labeled training data may be specified in the form of a dedicated variable, whose value is an integer, from 0 to z for instance, (0 corresponding to normal conditions, and 1 to z corresponding to the z possible abnormality causes ACₖ in the list).

In the embodiments described here, the list of abnormality causes comprises at least the following abnormality causes:
a given one of the actuators 3 of the steel processing line 1 is partially or totally inoperative; For instance a cooling jet or a radiant tube, is partially or totally inoperative; Distinct abnormality causes can be respectively associated to the different actuators, for instance to the different cooling jets (for instance 11 different abnormality causes if there are 11 different cooling jets in the line), so that the potentially malfunctioning actuator can be identified, in case an abnormality is detected,
a drift of one of the operation conditions, or of one of the intermediary properties of the steel semi-product, resulting in one of the monitoring signals MS to depart from a corresponding reference monitoring signal MS_{REF}; for instance a drift of the furnace gas temperature T_{g} or of that gas composition (for instance its HNx content), a drift of one of the skin-pass operation conditions, or a drift of the semi-product temperature at a given point in the line (the holding temperature, or the temperature after cooling, for instance), compared to a reference temperature desired at this point,
or a drift of one of the semi-product properties at the entrance of the processing line (drift of the chemical composition or of the dimension(s) of the product, or of past process parameters like the reducing radio of a preceding cold rolling operation).

Besides, in the embodiments described here, the labeled training data for which the steel processing data are abnormal, are simulated training data, produced by simulating what the line control signals output by the control module would be, in case one of the abnormality cause is present.

For each of these simulated training data, the steel processing data are simulated steel processing data each comprising:
a chemical composition CCᵢ of a steel semi-product,
one or more target property Pₘ for the steel semi-product, or one or more estimated final property P_{FAIL,k,i,l,m} of the steel semi-product, and
a set of virtual line control signals MP_{FAIL,l}, calculated assuming that the abnormality cause ACₖ is present.

The label associated to these simulated processing data specifies that they correspond to the abnormality cause ACₖ.

Each set of virtual line control signals MP_{FAIL,l} may, like here, be calculated:
as a function of the chemical composition CCᵢ and the one or more target properties Pₘ,
using the same steel predictive model and calculation rules as the one employed by the control module 11 for calculating the actual line control signals MP, and:
   a) are determined while forcing one of the virtual line control signals MP_{FAIL,l} to a value corresponding to a partial or total shut down of one of the actuators 3 of the steel processing line 1 (i.e.: forced to a value that would lead to a partial or total shut down of the actuator, if used for controlling the actuator), or
   b) is based on virtual monitoring signals, at least one of the virtual monitoring signals departing from the corresponding reference monitoring signal MS_{REF}.

As explained above when describing the control module 11, the control module is programmed so that it can determined line control signals given the constraint that one the of actuators 3 is off or partially off. This feature of the control module is employed, in case a) above, to determine the virtual line control signals MP_{FAIL,l} corresponding to a total or partial failure of one of the actuators.

In case b), the reference monitoring signal MS_{REF} may be the signal output by the corresponding sensor, recorded during an operation of the steel processing line considered as normal. In practice, an operation of the steel processing line may be considered as normal either when an operator in charge of the line judges, based on this experience and on the monitoring signals or other observations, that no abnormality occurred, or when a property actually obtained at the end of the process matches the target property P.

The reference monitoring signal MS_{REF} may also be a signal, calculated based on the chemical composition CCᵢ and the one or more target properties Pₘ, using said steel predictive model. For instance, if the monitoring signal considered is a temperature of the steel semi-product 6, measured by a pyrometer at the end of a cooling phase, the corresponding reference monitoring signal MS_{REF} may be a desired temperature at the end of cooling, according to a thermal path determined by the steel predictive model, given the chemical composition CCᵢ and the one or more target properties Pₘ.

In the embodiments described here, the trained classifier is trained, and tested, based on such simulated training data. The determination and gathering of the labeled training data, and the classifier training and testing may be achieved automatically by a computer programmed to this end. Once trained, the abnormality detector 12 is used in the steel processing line 1, to detect possible abnormalities, and to identify the corresponding causes.

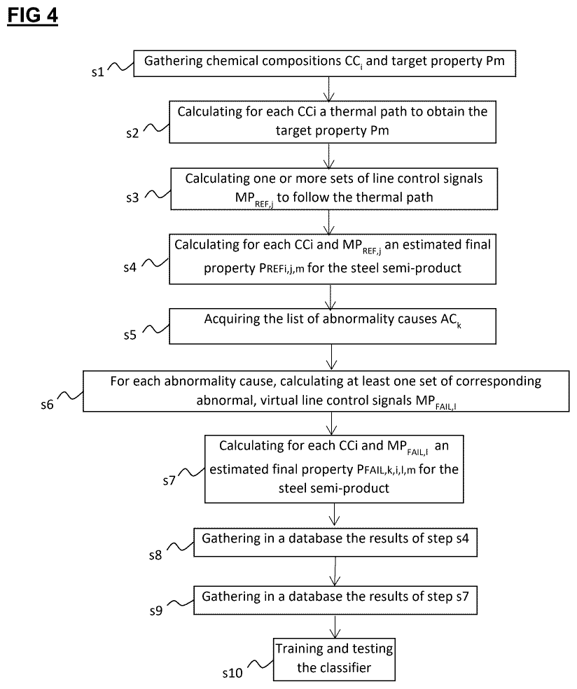

FIG. 4 represents steps executed in an exemplary method for obtaining simulated labelled training data, in a case where the steel semi-product process comprises thermal treatments, like the ones presented before.

### Step s1

As represented in FIG. 4, this method comprises a step s1 of gathering chemical compositions CCᵢ, i being an integer from 1 to x. Step s1 comprises also gathering formats (dimensions) and/or other initial properties of steel semi-products that can be processed by the steel processing line 1.

The chemical compositions CCᵢ, formats and other initial properties are preferably selected within a raw products database, the raw products database gathering data relative to products previously processed on the steel processing line 1.

The raw products database, which is an industrial production database, usually contains a huge number of data related to many different steel grades and formats.

The chemical compositions CCᵢ are selected among these data to correspond to a same, given steel grade. In practice, different steel semi-products (for instance different coils) of the same steel grade have individual chemical compositions varying slightly from one semi-product to the other, while remaining in a permissible chemical composition range (tolerance range) corresponding to the steel grade considered. The ensemble of chemical compositions CCᵢ is selected in the raw products database to be representative of this industrial dispersion of the chemical composition, for steel semi-product having the same steel grade. Still, limiting the selection to one given steel grade enables to reduce a lot the number of data to be subsequently employed for training the classifier.

The chemical compositions CCi are selected for instance by:
i) selecting, in the raw products database, chemical compositions of steel semi-products having all the same steel grade, and that have been processed on the steel processing line 1, during one or more production campaigns,
ii) among these chemical compositions, identifying representative clusters, and, possibly, identifying outlier chemical compositions and discarding them,
iii) Selecting some of the representative clusters, so that they cover homogeneously the range of chemical compositions of the chemical compositions selected in step i),
iv) Selecting the chemical compositions CCᵢ among the representative clusters selected in step iii).

Steps ii) to iv) may be parametrized so as to reduce the number of selected chemical compositions (between step i) and step iv)) by a factor of 5 or more, for instance.

The chemical compositions CCᵢ can be selected so that a ratio between the contents of two alloy elements remains the same, among the selected chemical compositions (indeed, such a ratio is usually constant, for steels produced using a same production process).

Selecting only some of the chemical compositions of the raw products database, for instance using the above procedure, is highly beneficial as a raw products database usually contains a huge number of data related to many different steel grades and formats. So, taking all of them into account to calculate many different corresponding training data, and then to train the classifier, would slow down extremely the training process.

Here, in contrast, the training data are gathered for one, given steel grade. And so, the trained classifier obtained based on this will be suitable for detecting an abnormality when the processed steel semi-product 6 is of that same steel-grade (in other words, the classifier, is specific to one kind of steel grade).

The number x of chemical compositions CCᵢ selected is for instance from 2 to 1000, more preferably from 10 to 1000 and even more preferably from 10 to 500.

The steel semi-product formats may be selected using a method identical or similar to the one presented above the chemical composition selection.

In step s1, the one or more target properties Pₘ are also selected, for instance in the same raw products database.

### Step s2

Step s2 comprises calculating, for each chemical composition CCᵢ and target property or properties Pₘ gathered at step s1, a thermal path TP_{REF,i,m} in order to obtain at the end of the thermal treatment, the one or more target properties Pₘ (eg: target tensile strength and target microstructure), or properties close to them. The thermal path TP_{REF,i,m} is calculated using the same steel predictive model as the one of the control module 11.

The thermal path TP_{REF,i,m} comprises for instance the successive temperatures, heating and cooling rates and time spent in each section of the thermal treatment process.

Additional reference thermal paths may also be determined, from the thermal path TP_{REF,i,m} calculated as explained above, by modifying slightly the thermal path within a typical industrial variability range (to take into account typical fluctuations of the thermal path occurring in practice, even with no abnormality).

### Step s3

For each thermal path TP_{REF,i,m}, and possibly for each additional reference thermal paths, one or more sets of line control signals MP_{REF,j}, j being an integer from 1 to y, are calculated in order for the steel semi-product to follow such thermal path. The one or more sets of line control signals MP_{REF,j}, are calculated using the same calculation rules as the one employed by the control module 11. y may be higher than 1, as there may be different possible combinations, for controlling the actuators so as to obtain the thermal path TP_{REF,i,m}, as explained above when describing the control module 11. In practice there are numerous possible combinations for controlling the jets to obtain the desired thermal path TP_{REF,i,m} (in other words, there are many different possibilities to distribute the total cooling power required among jets). For instance, one may have J1=J2=J3=90%, but also J1=85%, J2=90%, J3=95%, or J1=85%, J2=92%, J3=93% and so on. Typically, with eleven cooling jets, there are hundreds of slightly different combinations enabling to follow the desired thermal path TP_{REF,i,m}, and leading to extremely close final properties, for instance leading to the same tensile strength value, with variations from one jet combination to the other that are smaller than 0.05%. In other words, there are many different jet configurations that correspond to normal operation, for a given target thermal path. So, many such possible sets of line control signals MP_{REF,j}, and corresponding training data, is very beneficial regarding the classification accuracy. Indeed, it helps the classifier distinguishing a jet power variation corresponding to a drift, from a variation corresponding one of the numerous possibilities for normal operation. So, in practice, y may be chosen quite high (higher than 10, or even higher than 20 or 100). For instance, for an ensemble of 11 cooling jets, y may be comprised between 20 and 2000, more preferably between 100 and 1000.

### Step s4

Then, in step s4, for each chemical composition CCᵢ, and combination of manufacturing parameters MP_{REF,j}, the one or more estimated final properties P_{REF,i,j,m} expected at the end of the thermal treatment (including typically the resulting microstructure M_{REFi,j,m}) are calculated (using the same calculation rules as the one employed by the control module), thereby defining reference states.

### Step s5

Step s5 comprises acquiring the predetermined list of abnormality causes ACₖ presented above, k being an integer from 1 to z. In a preferred embodiment, z is from 2 to 100, more preferably from 10 to 50 and even more preferably from 20 to 50. This list of possible abnormality causes, or in other words of possible failure scenarios, is intended to be as exhaustive as possible. However, an abnormality cause called “unknown cause” can be added to the list, in order to take into account a drift or failure that might have been forgotten or never seen.

### Step s6

For each abnormality causes ACₖ, step s6 comprises calculating at least one set of corresponding abnormal, virtual line control signals MP_{FAIL,l} to simulate said abnormality, l being an integer from 1 to a. These abnormal, virtual line control signals MP_{FAIL,l} are calculated are explained above, in the general presentation of the abnormality detector 12. a is equal to y, or of the same order of magnitude as y. In particular, a may be higher than 10, or even higher than 20 or 100.

### Step s7

Step s7 comprises calculating, for each abnormality causes ACₖ, composition CCi, and each set of abnormal, virtual line control signals MP_{FAIL,l}, the one or more estimated final properties P_{FAILk,i,l,m} (typically including the microstructure M_{FAILk,i,l,m} resulting from this processing). The calculations rules employed to this end can be the same as the one employed in step s4.

### Steps s8 and s9

In step s8, the results obtained at step s4 are gathered in the form of labeled training data, each gathering, inter alia, one of the chemical compositions, CCᵢ, one of the estimated final propertie(s) P_{REF,i,j,m}, and the corresponding set of line control signals MP_{REF,j}, the training data being labeled as normal. Each of these labeled training data may also comprise one or more of the reference monitoring signals MS_{REF} mentioned above (representing signals that would be measured on the line, in practice). Here, these reference monitoring signals MS_{REF} comprise at least some of the successive temperature points of the reference thermal path TP_{REF,i,m} determined in step s2. These labeled training data are gathered in a database. This database may, like here, be completed based on training data that are actual production data, recorded during the operation of the steel processing line 1.

In step s9, the results obtained at step s7 are gathered in the form of labeled training data, each gathering, inter alia, one of the chemical compositions CCᵢ, one of the estimated final propertie(s) P_{FAIL,k,i,l,m} and the corresponding set of abnormal, virtual line control signals MP_{FAIL,l} j, the labeled training data being labeled as abnormal, the abnormality cause being ACₖ. Each of these labeled training data may also comprise one or more of the virtual monitoring signals mentioned above (representing signals that would be measured on the line, in practice, in case of malfunction or drift). These labeled training data are also gathered in the above mentioned database. This database may also be completed by actual production data, recorded during an operation of the steel processing line 1 considered as abnormal, when such data is available.

### Step s10

In step s10, the classifier is trained and tested, using the labeled training data previously obtained.

The classifier may be soft classifier, wherein the probability associated to each class (that is to each abnormality cause, plus the normal case), is estimated, and the chosen class is based on the estimated probabilities.

One part of a database, gathering the labeled training data is used as a training database to train the classifier to classify the information corresponding to normal or abnormal processing conditions. The class associated to a reference, normal operation may be the class 0. Preferably, from 70% to 80% of the database is used for the training database.

The rest of the database is then used as a test database to determine the accuracy of the trained classifier. Preferably, from 20% to 30% of the database is used for such testing. Preferably, the validation used is a stratified cross-validation, meaning that this validation consists in ensuring that the distribution of classes is the same in the training and test data base used.

To evaluate the accuracy of the classifier to classify the information in the correct class, the alpha and beta risks for each classification tools are calculated for each class:
The risk alpha (a) represents the probability of classifying abnormal control signals as normal, which can be considered as a false negative. (1−α)=1, or close to 1, corresponds therefore to a good classification.
The risk beta (B) represents the probability of classifying normal control signals as abnormal ones, which can be considered as a false positive. (1−β)=1, or close to 1 corresponds therefore to a good classification.

The accuracy expressed in %, is calculated as an average, over the different classes, of the values of (1−α) or of (1−β).

The classifier type can be chosen among various types of classifiers, including: decision tree (dt) in particular the C4.5 algorithm, random forest (rf), extra trees (et), Adaptative Boosting (ab), Gaussian Naives Baye (gnb), or Support Vector Machines (SVM).

The inventors have observed that, for the application concerned here, decision-tree based classifiers (possibly multiple-trees ones) worked well, in particular better than Support Vector Machines.

The inventors have observed also that “pre-guided” multiple-trees classifiers provided good classification accuracy. By “pre-guided” it is meant a classifier based on multiple elementary decision trees, wherein each elementary decision trees is trained using a set of labelled training data having the same abnormality cause ACₖ. So, this elementary decision tree will perform very well for detecting this abnormality cause ACₖ (and not so well for the other abnormality causes, the overall performance of the classifier being obtained by combining the decisions made by the different elementary trees). This pre-guided training method can be implemented by selecting adequately the training data employed for each tree, during the training of a random forest-like classifier, for instance.

Here, the same classifier is employed to detect the different abnormality causes. Alternatively, distinct trained classifiers, each dedicated to one (or a few) of the abnormality causes, could be employed respectively for the detection of the different abnormality causes.

After this initial set up phase is being performed, the classifier can then be used in the steel processing line 1, to detect possible abnormalities.

### Countermeasures

The electronic device 10 of the steel processing line 1 may be configured, for instance programmed to determine a criticality indicator, when the abnormality indicator ind specifies that the line control signals MP are abnormal. The criticality indicator is determined based on the abnormality cause ACₖ and is possibly based also on a difference between the one or more estimated final properties P_{EST} of the steel semi-product 6, and the one or more target properties P. The criticality indicator specifies whether the abnormality is noncritical, critical, or urgent.

A noncritical abnormality corresponds for instance to a case when a malfunction or drift is detected, but the final properties of the steel semi-product, in particular P_{EST} are not expected to deviate from a tolerated, compliance range.

A critical abnormality corresponds for instance to a case when the final properties of the steel semi-product, in particular P_{EST} are expected to deviate from the tolerated, compliance range, but subsequent repair of the steel semi-product, or online compensation is considered possible.

An urgent abnormality corresponds for instance to a case where the steel semi-product is expected to be non-compliant, and non-repairable.

The electronic device may be further configured to execute the following procedure:
In case of noncritical abnormality, a warning message, indicating said abnormality cause and prompting to fix the malfunction or drift cause at a next planned line stopping, is emitted,
In case of critical abnormality, a critical warning message, prompting to adjust parameters of a subsequent processing (or even parameters of the in-course processing) to compensate for said abnormality, is emitted, or, the parameters of said processing are automatically adjusted to compensate for said abnormality, and
In case of urgent abnormality, the steel processing line 6 is stopped.

The invention will be now further illustrated by the following example, which is by no way limitative.

### Example

A steel sheet having a chemical composition CC comprising 0.15% wt of C, 1.90% wt of Mn, 0.20% wt of Si, 0.20% wt of Cr, 0.003% wt of Mo, 0.017% wt of P, 0.005% wt of N, 0.015% wt of Cu and 0.023% wt of Ti, the remainder of the composition being iron and unavoidable impurities resulting from the smelting, has to be produced following the successive steps:
a. casting in semi-product
b. reheating step
c. hot rolling
d. coiling at a temperature T_{coil}
e. cold rolling at a reduction rate CRᵣₐₜₑ
f. a preheating step, wherein the steel sheet is heated to a temperature T1,
g. a heating step, wherein the steel sheet is heated from T1 to a temperature T2,
h. a holding step, wherein the steel sheet is held during a holding time t at a temperature of T2, with an end of holding temperature T3,
i. a cooling step in a snout, wherein the steel sheet is cooled from T3 to a snout temperature T4 with 11 jets cooling spraying HNx,
j. a hot dip coating step, at a speed v_{GAL} in a zinc bath having a temperature T5, corresponding to an isothermal holding at such temperature,
k. a cooling step until the top roll temperature T6
l. and a cooling step at room temperature,
   in order to obtain a steel sheet having targeted properties P, comprising a tensile strength TS of 820 MPa, and a yield strength YS of 500 MPa, and a targeted microstructure M, comprising in surface fraction 31% of ferrite, 54% of bainite, the rest being martensite.

The thermal path consists in steps f to l, the former steps being realized previously on another manufacturing line.

### Step s1: Gathering Chemical Compositions Data

Table 1 gathers the 15 chemical compositions CCᵢ selected, according to the method described above in reference to FIG. 4, for the steel grade considered here. The elements contents for these chemical compositions are expressed in weight percent (% wt.). In this example, just one set of target properties (TS=820 MPa; YS=500 MPa; and the microstructure above defined) are considered.

TABLE 1
selected chemical compositions CCᵢ

| (% wt) | C | Mn | Si | Cr | Mo | P | Cu | Ti | N |
|---|---|---|---|---|---|---|---|---|---|
| i = 1 | 0.1502 | 1.879 | 0.1998 | 0.1875 | 0.003 | 0.0161 | 0.0173 | 0.0228 | 0.0048 |
| 2 | 0.1446 | 1.8873 | 0.2079 | 0.1901 | 0.0035 | 0.0165 | 0.0123 | 0.0225 | 0.0039 |
| 3 | 0.140 | 1.8576 | 0.2044 | 0.1838 | 0.0027 | 0.0148 | 0.0162 | 0.0245 | 0.0043 |
| 4 | 0.1505 | 1.8893 | 0.2118 | 0.1812 | 0.0033 | 0.0177 | 0.0112 | 0.0244 | 0.0041 |
| 5 | 0.1553 | 1.8963 | 0.2106 | 0.1792 | 0.0023 | 0.018 | 0.0141 | 0.0238 | 0.0039 |
| 6 | 0.1493 | 1.8948 | 0.2077 | 0.1932 | 0.0043 | 0.0156 | 0.0345 | 0.0259 | 0.0059 |
| 7 | 0.1482 | 1.9102 | 0.2158 | 0.1971 | 0.0032 | 0.0225 | 0.0095 | 0.0244 | 0.0052 |
| 8 | 0.1488 | 1.8862 | 0.2022 | 0.1977 | 0.0025 | 0.0173 | 0.0148 | 0.0217 | 0.0039 |
| 9 | 0.1422 | 1.8905 | 0.2049 | 0.1987 | 0.0043 | 0.0189 | 0.0156 | 0.0242 | 0.0035 |
| 10 | 0.1505 | 1.8744 | 0.2019 | 0.1949 | 0.0025 | 0.0173 | 0.0156 | 0.0214 | 0.0045 |
| 11 | 0.1493 | 1.8956 | 0.2046 | 0.1919 | 0.0038 | 0.0147 | 0.0129 | 0.0247 | 0.0057 |
| 12 | 0.1517 | 1.8881 | 0.2039 | 0.1936 | 0.0043 | 0.0169 | 0.0124 | 0.0024 | 0.0048 |
| 13 | 0.1381 | 1.8955 | 0.2104 | 0.1769 | 0.0028 | 0.0166 | 0.0125 | 0.0218 | 0.0042 |
| 14 | 0.146 | 1.8808 | 0.1984 | 0.1846 | 0.0032 | 0.0179 | 0.0081 | 0.0218 | 0.0052 |
| 15 | 0.1482 | 1.8837 | 0.2064 | 0.1797 | 0.0029 | 0.0182 | 0.0136 | 0.0225 | 0.0045 |

### Step s2: Defining the Reference Thermal Paths

For each sheet of chemical composition CCᵢ gathered at step 1, the reference thermal paths, enabling to obtain at the end of the thermal treatment a microstructure and properties as close as possible to the targeted ones, are determined, according to the method presented above with reference to FIG. 4. These thermal paths comprise temperatures, times and heating and cooling rates. Table 2 gathers the temperatures at the end of each phase, for each CCᵢ. The heating and cooling rates are not specified in table 2, for the sake of conciseness, as they vary (slightly) depending on the different sheet formats considered for each chemical composition.

TABLE 2
Thermal paths

| | | | | | Hot-dip | |
|---|---|---|---|---|---|---|
| | Pre-heating | Heating | Holding | Cooling | coating | Top roll |
| Steel | T1 (° C.) | T2 (° C.) | T3 (° C.) | T4 (° C.) | T5 (° C.) | T6 (° C.) |
| 1 | 734 | 833 | 832 | 460 | 461 | 321 |
| 2 | 756 | 829 | 836 | 458 | 460 | 311 |
| 3 | 776 | 841 | 851 | 463 | 461 | 310 |
| 4 | 725 | 793 | 818 | 448 | 461 | 313 |
| 5 | 735 | 832 | 825 | 460 | 465 | 322 |
| 6 | 740 | 831 | 830 | 463 | 462 | 311 |
| 7 | 736 | 843 | 832 | 462 | 461 | 310 |
| 8 | 734 | 830 | 832 | 476 | 461 | 315 |
| 9 | 755 | 833 | 836 | 450 | 460 | 308 |
| 10 | 756 | 843 | 826 | 464 | 458 | 334 |
| 11 | 740 | 831 | 830 | 463 | 462 | 311 |
| 12 | 754 | 846 | 834 | 457 | 459 | 311 |
| 13 | 730 | 824 | 822 | 456 | 459 | 313 |
| 14 | 750 | 842 | 830 | 458 | 460 | 314 |
| 15 | 736 | 843 | 832 | 462 | 461 | 310 |

### Step s3: Determination of the Line Control Signals MP_{REF,i,j} Enabling to Obtain the Thermal Path

Step s3 is achieved as explained above with reference to FIG. 4, with a value of y comprised between 500 and 700.

Step s4: Calculating References M_{REFi,j} and P_{REFi,j}

For each CCᵢ and combination of jet powers, the reference properties P_{REFi,j} (including the reference microstructure M_{REFi,j}), without jet failures or other abnormality, obtained at the end of the thermal treatment process are then calculated as explained above. These properties are the tensile strength TS, the yield strength YS, and the microstructure (defined as the respective surface fractions of ferrite, bainite, martensite and possibly perlite).

Steps s5 to s10 are then executed, as explained above with reference to FIG. 4. 11 abnormality causes are considered here, each associated, respectively, to a failure (complete shut-down) of one of the 11 cooling jets of the cooling device.

The ‘normal’ labeled training data thus gathered each include: one of the chemical composition CCᵢ, one of the associated line control signals MP_{REF,i,j} and the corresponding estimated final properties P_{REFi,j}, and also the temperature set points T1-T6 of the reference thermal path TP_{REF,i} (these set points playing the role of line monitoring signals, that would have been measured by the sensors, on the actual processing line).

The ‘abnormal’ labeled training data have a similar structure as the ‘normal’ labelled training data.

The classifier is configured for classifying data in 12 classes. The class n=0 corresponds to normal line control signals (and thus a normal operation). Classes n=1 to 12 are respectively associated to a failure of the colling jet number n.

Accuracies obtained after training are gathered in table 3, for the case of a random forest classifier (rf) and for the case of an extra trees classifier (et). The training was carried on with 70% of the database, and the accuracy test was carried on with 30% of it. The database comprises around 45000 different training data for each class (the different classes are evenly represented, in the database). For the class n=0, the data in the data base comprises actual production data recorded during the operation of the line, as well as simulated data. In table 3, the quantity “1” in indicate when the quantity is equal to or higher than 0.999.

TABLE 3
Accuracy of the classifiers

| Classifier | |
|---|---|
| rf | et |

| | (1-α) | (1-β) | (1-α) | (1-β) |
|---|---|---|---|---|
| Class 0 | 1 | 1 | 0.971 | 1 |
| Class 1 | 1 | 1 | 1 | 1 |
| Class 2 | 1 | 1 | 1 | 1 |
| Class 3 | 1 | 1 | 1 | 1 |
| Class 4 | 1 | 1 | 1 | 0.972 |
| Class 5 | 1 | 1 | 1 | 1 |
| Class 6 | 1 | 1 | 1 | 1 |
| Class 7 | 1 | 1 | 1 | 1 |
| Class 8 | 1 | 1 | 1 | 1 |
| Class 9 | 1 | 1 | 1 | 1 |
| Class 10 | 1 | 1 | 1 | 1 |
| Class 11 | 1 | 1 | 1 | 1 |
| Accuracy (%) | 100 | 100 | 99.76 | 99.76 |

These classifiers show excellent results of classification. Tests carried on dt (C4.5), ab and gnb show also excellent classification results.

What is claimed is:

1-20. (canceled)

21. A method for monitoring a steel processing line during the processing of a steel semi-product, the steel processing line including sensor, actuators and an electronic device having a control module and an abnormality detector, method comprising:
acquiring, via the control module:
a chemical composition CC of the steel semi-product;
a target property P for the steel semi-product, to be obtained at the end of said processing;
monitoring signals, output by the sensors of the steel processing line, the monitoring signals being representative of operation conditions, or of intermediary properties of the steel semi-product,
determining line control signals for controlling the actuators of the steel processing line, the line control signals being determined as a function of the chemical composition CC, the target property P and the monitoring signals, and being determined using a steel property predictive model,
controlling the actuators based on the line control signals,
and wherein the abnormality detector determines and outputs an abnormality indicator specifying whether the line control signals are normal or abnormal, an abnormality cause selected in a list of predetermined abnormality causes being then specified, the abnormality indicator being determined using a trained classifier, the trained classifier inputs comprising:
the chemical composition CC of the steel semi-product,
the target property P, or an estimated final property P_{EST} of the steel semi-product determined by the control module, and
the line control signals,
the trained classifier having been previously trained using a plurality of labeled training data, each labeled training data comprising:
steel processing data, of the same type as the trained classifier inputs, and
a label, specifying whether the steel processing data are normal or abnormal, one of the abnormality causes of the list being then specified.

22. The method as recited in claim 21 wherein the predetermined list of abnormality causes comprises one or more of the following abnormality causes:
a given one of the actuators of the steel processing line is partially or totally inoperative,
a drift of one of the operation conditions, or of one of the steel semi-product intermediary properties, resulting in one of the monitoring signals to depart from a reference monitoring signal.

23. The method as recited in claim 21 wherein, for some of the labeled training data:
the steel processing data are simulated steel processing data, calculated while one the abnormality causes is present, and
the label associated to said steel processing data specifies that said abnormality cause is present.

24. The method as recited in claim 23 wherein each simulated steel processing data comprise:
a chemical composition CCᵢ of a steel semi-product,
a target property Pₘ for the steel semi-product, or an estimated final property P_{FAIL,k,i,l,m} of the steel semi-product, and
a set of virtual line control signals calculated while taking into account that said abnormality cause is present.

25. The method as recited in claim 24 wherein the predetermined list of abnormality causes comprises one or more of the following abnormality causes:
a given one of the actuators of the steel processing line is partially or totally inoperative,
a drift of one of the operation conditions, or of one of the steel semi-product intermediary properties, resulting in one of the monitoring signals to depart from a reference monitoring signal; and
wherein each set of virtual line control signals (MP_{FAIL,1}) is calculated:
as a function of the chemical composition CCi and the target property Pₘ,
using the same steel predictive model and calculation rules as the one employed by the control module for calculating the line control signals, and:
being determined while forcing one of the virtual line control signals to a value corresponding to a partial or total shut down of one of the actuators of the steel processing line, or
being based on virtual monitoring signals, at least one of the virtual monitoring signals departing from the corresponding reference monitoring signal.

26. The method as recited in claim 25 wherein the reference monitoring signal is calculated, based on the chemical composition CCᵢ and the target property Pₘ, using the steel predictive model.

27. The method as recited in claim 24 wherein:
the chemical compositions CCᵢ are selected within a raw products database gathering data relative to products previously processed on the steel processing line, by selecting products listed in the raw products database and that correspond to a same steel grade, the selected products having chemical compositions that are homogeneously distributed among a range of permissible chemical compositions for said steel grade.

28. The method as recited in claim 24 wherein the steel semi-product undergoes a thermal treatment, and wherein the determination of the simulated steel processing data comprises the following steps:
s2: calculating, for each chemical composition CCᵢ and target property Pₘ, a thermal path TP_{REF,i,m} to obtain the target property Pₘ at the end of the thermal treatment, said calculation being based on said steel predictive model,
s3: determining one or more sets of line control signals MPj to follow said thermal path TP_{REF,i,m}, j being an integer from 1 to y,
s4: calculating for each chemical composition CCᵢ and set of line control signals MP_{REF,}j, an estimated final property PREF,i,j,m obtained at the end of the thermal treatment,
s5: acquiring said predetermined list of abnormality causes ACₖ, k being an integer from 1 to z,
s6: for each abnormality cause ACₖ, calculating at least one set of corresponding abnormal, virtual line control signals to simulate said abnormality, l being an integer from 1 to a,
s7: for each abnormality cause ACₖ, composition CCᵢ, and set of abnormal, virtual line control signals, calculating the estimated final property PFAIL,k,i,l,m, expected at the end of the thermal treatment,
s8: gathering the results obtained at step s4 in the form of labeled training data, each gathering at least: one of the chemical compositions CCᵢ, one of the estimated final properties P_{REF,i,j,m} and the corresponding set of line control signals and being labeled as normal steel processing data,
s9: gathering the results obtained at step s7 in the form of labeled training data, each gathering at least: one of the chemical compositions CCᵢ, one of the estimated final properties PFAIL,k,i,l,m and the corresponding set of abnormal, virtual line control signals and being labeled as abnormal, the abnormality cause being ACₖ.

29. The method as recited in claim 28 wherein y and a are each higher than 10.

30. The method as recited in claim 21 wherein the trained classifier inputs further comprise one or more of the monitoring signals.

31. The method as recited in claim 21 wherein the trained classifier is a decision-tree based classifier.

32. The method as recited in claim 21 wherein the trained classifier is based on multiple elementary decision trees, at least some of the elementary decision trees being each trained using a set of labeled training data having the same abnormality cause.

33. The method as recited in claim 21 wherein the control module determines the line control signals taking also into account one or more process parameters of a previous process underwent by the steel semi-product before being processed in said steel processing line.

34. The method as recited in claim 21 wherein, when the abnormality indicator specifies that the line control signals are abnormal, then, a criticality indicator is determined based on the abnormality cause ACₖ and the estimated final property P_{EST} of the steel semi-product, the criticality indicator specifying whether the abnormality is noncritical, critical, or urgent, and:
in case of noncritical abnormality, a warning message, indicating said abnormality cause and prompting to repair at a next planned line stopping, is emitted,
in case of critical abnormality, a critical warning message, prompting to adjust parameters of a subsequent processing to compensate for said abnormality, is emitted, or, the parameters of said subsequent processing are automatically adjusted to compensate for said abnormality, and
in case of urgent abnormality, the steel processing line is stopped.

35. The method as recited in claim 21 wherein the steel processing line comprises one of the following, or a combination thereof: a furnace, a mill, a runout table, a hot-rolling line, a cold-rolling line, a pickling line, a thermal treatment installation, a hot-dip galvanization line.

36. The method as recited in claim 21 wherein the steel semi-product is a steel sheet.

37. An electronic device for controlling a steel processing line having sensors and actuators and suitable for processing a steel semi-product, the electronic device comprising a control module and an abnormality detector
the control module being configured to execute the following steps:
acquiring:
a chemical composition CC of the steel semi-product;
a target property P for the steel semi-product, to be obtained at the end of said processing;
monitoring signals, output by the sensors of the steel processing line, the monitoring signals being representative of operation conditions, or of intermediary properties of the steel semi-product,
determining line control signals for controlling the actuators of the steel processing line, the line control signals being determined as a function of the chemical composition CC, the target property P and the monitoring signals, and being determined using a steel property predictive model, and
controlling the actuators based on the line control signals,
the abnormality detector being configured to determine and output an abnormality indicator specifying whether the line control signals are normal or abnormal, an abnormality cause selected in a list of predetermined abnormality causes being then specified, the abnormality indicator being determined by a trained classifier, the trained classifier inputs comprising:
the chemical composition CC of the steel semi-product,
the target property P, or an estimated final property P_{EST} of the steel semi-product determined by the control module, and
the line control signals,
wherein the trained classifier is a classifier that has been previously trained using a plurality of labeled training data, each labeled training data comprising:
steel processing data, of the same type as the trained classifier inputs, and
a label, specifying whether the steel processing data are normal or abnormal, one of the abnormality causes of said list being then specified.

38. A steel processing line comprising sensors, actuators, and the electronic device as recited in claim 37.

39. A method for training a classifier of an abnormality detector of an electronic device, the electronic device having a control module for controlling a steel processing line having sensors and actuators and suitable for processing a steel semi-product,
the control module being configured to execute the following steps:
acquiring:
a chemical composition CC of the steel semi-product;
a target property P for the steel semi-product, to be obtained at the end of said processing;
monitoring signals, output by the sensors of the steel processing line, the monitoring signals being representative of operation conditions, or of intermediary properties of the steel semi-product,
determining line control signals for controlling the actuators of the steel processing line, the line control signals being determined as a function of the chemical composition CC, the target property P and the monitoring signals, and being determined using a steel property predictive model,
controlling the actuators based on the line control signals,
method wherein the classifier is trained using a number of labeled training data, each labeled training data comprising:
steel processing data, of the same type as the trained classifier inputs, and
a label, specifying whether the steel processing data are normal or abnormal, one of the abnormality causes of said list being then specified,
wherein at least some of the labeled training data are simulated training data calculated using the same steel predictive model and the same calculation rules as the one employed by the control module for calculating said line control signals and while one of said abnormality cause is present.

40. A computer program comprising instructions whose execution on a computer device, connected to sensors and actuators of a steel processing line, make the computer device execute the method according to claim 21.
